(19) United States
(12) Patent Application Publication
(10) Pub. No.: US 2015/0259032 A1
(43) Pub. Date: Sep. 17, 2015

(54) SNOW VEHICLE SKI

(71) Applicant: Polaris Industries Inc., Medina, MN (US)

(72) Inventor: Allen Mangum, Ponderay, ID (US)

(21) Appl. No.: 14/659,336

(22) Filed: Mar. 16, 2015

Related U.S. Application Data
(60) Provisional application No. 61/953,825, filed on Mar. 15, 2014.

(51) Int. Cl. B62M 27/02

(52) U.S. Cl. CPC B62M 27/02; B62M 2027/021; B62M 2027/025

(57) ABSTRACT

A system and device are provided for a snow vehicle ski. The system includes a snow ski with a bottom surface for gliding over snow and ice, where the base extends longitudinally from a tip to a tail. The snow ski also includes a first keel extending along a first lateral edge of the base, a second keel extending along a second lateral edge of the base, and a third keel extending along a longitudinal axis of the base, and where the third keel extends downwardly from the base a distance greater than the first keel. The system includes wear bars coupled to each of the first, second, and third keels. The device includes a wear bar for attachment to a bottom of a snow vehicle ski, where the wear bar comprises a pair of downwardly extending ridges forming a concave region extending along a length of the wear bar.

### CROSS-REFERENCES TO RELATED APPLICATIONS

This application claims the benefit of and claims priority to U.S. Provisional Patent Application No. 61/953,825 entitled “SNOW VEHICLE SKI” and filed on Mar. 15, 2014 for Allen Mangum, which is incorporated herein by reference.

### TECHNICAL FIELD

The present disclosure relates in general to tracked vehicles and in particular to wear bars attached to a bottom surface of a ski for turning on snow covered terrain.

### BACKGROUND

Tracked vehicles have long been used for travel over snow. Generally, snowmobiles are used for various applications including trail riding, mountain riding, and touring. Additionally, many types of wheeled vehicles have been converted for travel over snow and ice. For example, Ford Model-T automobiles and even older types were long ago converted for use in winter snows by bolting drive tracks and skis where the wheels were originally.

Tracked vehicles differ from wheeled vehicles in that tracked vehicles may travel over snow-covered terrain in any direction that an operator desires. In other words, tracked vehicles are not bound to roads and trails. Typically, a tracked vehicle comprises an elongated rubberized looped track that propels the vehicle over the snow-covered terrain. One or more skis steer the vehicle. The ski is attached to a steering mechanism of the vehicle, and may be provided with suspension components to handle bumps. With the use of handle bars, for example, the operator is able to alter the facing of the ski. Turning the ski in a selected direction generally causes the vehicle to follow the selected direction of travel of the ski. Steering may also be accomplished by leaning or tilting the vehicle to one side or the other, especially if the vehicle utilizes a mono-ski.

Generally, skis are smooth and flat with a single shallow extending along the center of the ski to exert a lateral shear force against the snow when the ski is turned. This forces the ski to adhere to an intended direction of travel. Skis with multiple keels have also been developed.

One or more wear bars may be located on the bottom of the ski. The wear bar enhances the turning ability of the ski especially on hard packed snow and ice. Even with the use of keels and wear bars, conventional skis may still experience lateral slippage on hard packed surfaces. The sliding of the ski in the original direction of travel, instead of following an intended direction of travel, is termed “pushing.”

### SUMMARY

A system and device are provided for a snow vehicle ski. The system includes a snow ski with a bottom surface for gliding over snow and ice, where the base extends longitudinally from a tip to a tail. The snow ski also includes a first keel extending along a first lateral edge of the base, a second keel extending along a second lateral edge of the base, and a third keel extending along a longitudinal axis of the base, and where the third keel extends downwardly from the base a distance greater than the first keel. The system includes wear bars coupled to each of the first, second, and third keels.

Each of the wear bars comprises an elongated, hardened member comprising a pair of downwardly extending ridges along the lateral edges of the elongated, hardened member. In one embodiment, the pair of downwardly extending ridges form a concave region. Each of the wear bars includes a top surface that is contoured to engage a corresponding one of a plurality of channels formed in one of either the first keel, the second keel, or the third keel.

In one embodiment, each of the plurality of wear bars includes an upturned tip configured to engage a slope of one of either the first, second, or third keel. The upturned tip may include a raised portion configured to engage an opening in one of either the first keel, the second keel, or the third keel. In another embodiment, each of the wear bars comprises a substantially half-circular lateral cross-sectional profile.

In one embodiment, a distance between the pair of downwardly extending ridges is in the range of between about 0.25 and 0.5 inches.

The device, in one embodiment, comprises a wear bar assembly comprising a wear bar for attachment to a bottom of a snow vehicle ski, where the wear bar comprises a pair of downwardly extending ridges forming a concave region extending along a length of the wear bar.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a side view diagram illustrating one embodiment of a track conversion system for a motorcycle in accordance with embodiments of the invention;

FIG. 2 is a perspective view diagram illustrating one embodiment of the ground engaging surface of the ski steering assembly in accordance with embodiments of the invention;

FIG. 3 is a perspective view diagram illustrating another embodiment of the ground engaging surface in accordance with embodiments of the invention;

FIGS. 4a and 4b are perspective view diagrams illustrating embodiments of wear bars in accordance with embodiments of the invention; and

FIG. 5 is a schematic block diagram illustrating one embodiment of a ski cross-section in accordance with embodiments of the invention.

### DETAILED DESCRIPTION

The subject matter of the present application has been developed in response to the present state of the art, and in particular, in response to the problems and needs in the art that have not yet been fully solved by currently available snow vehicle skis. Accordingly, the subject matter of the present application has been developed to provide a wear bar and a ski that overcomes at least some shortcomings of the prior art.

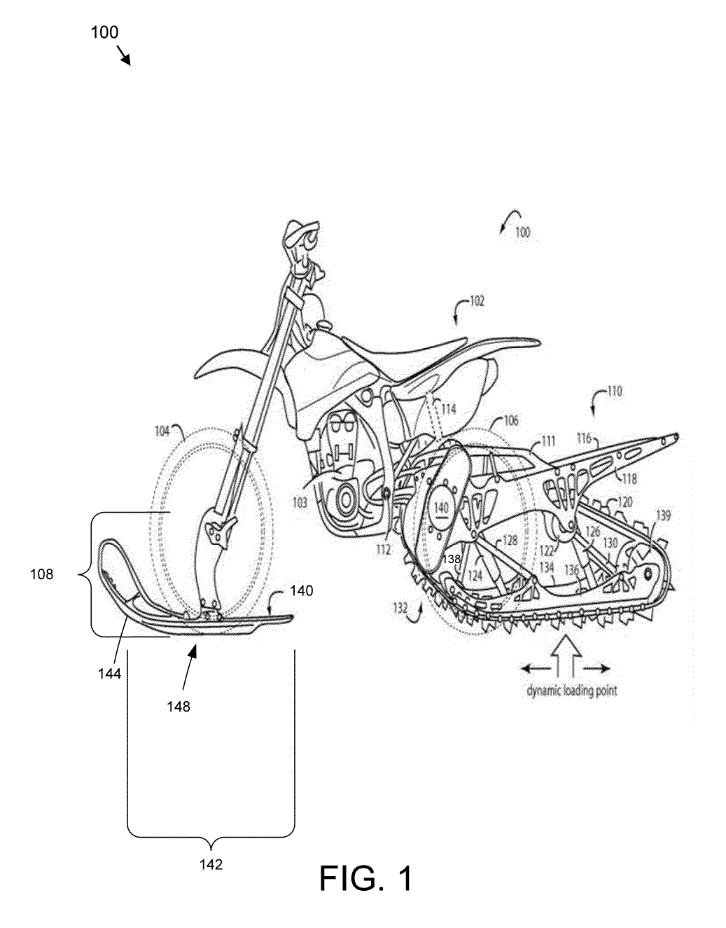

FIG. 1 is a side view diagram illustrating one embodiment of a track conversion system for a motorcycle in accordance with embodiments of the invention. The track conversion system 100 comprises, in one embodiment, a motorcycle 102 with an engine 103 which has had its front wheel 104, rear wheel 106, and rear swing-arm suspension removed. In one embodiment, a single front steering ski 108 and a rear track drive assembly 110 replace the front wheel 104 and the rear wheel 106, respectively. Examples of a front steering ski 108 capable of use with embodiments of the invention include a dual- or tri-keel ski manufactured by Simmons, Inc. of Providence, Utah.

The rear track drive assembly 110, in one embodiment, includes a tubular subframe 111 that attaches to the motorcycle 102 with a rear swing arm pin 112 and a solid strut 114 that replaces the original shock. The top part of the rear track drive assembly 110 is thus rigidly attached with the frame of the motorcycle and does not move with reference to the frame. A tunnel assembly 116 attaches to both sides of the tubular subframe 111 with tunnel side skirts 118 and provides protective cover for the top of a drive track 120 and mounting for a track roller 122, forward and aft adjustable shocks 124 and 126, and forward and aft track struts 128 and 130. One example of a track suitable for use with the rear track drive assembly 110 is a Camoplast Challenger Track, 121″ long, 12¾″ wide, 1¾″ deep lug, manufactured by Camoplast of Quebec Canada.

The forward and aft shocks 124 and 126, and the forward and aft track struts 128 and 130 together support a hyfax slide suspension 132. A hyfax is a sacrificial plastic glide which runs the length of two parallel rear suspension rails 134 and 136 on both sides. Polystyrene and graphite glide materials can be used because they provide very smooth contact surfaces to the track 120 and low operational friction especially when lubricated with snow.

An adjustable limit strap 138 controls the initial upward tilt of the hyfax slide assembly 132 to the ground and snow underneath. The limiter strap 138 may include adjustment holes in the middle of the strap. Shortening the limiter strap 138 will increase pressure on the front ski 108 and will provide more steering control on steep slopes. Conversely, lengthening the limiter strap 138 will lighten the front ski pressure. Adjusting the limiter strap shifts the center of gravity either forwards or towards the rear, thereby adjusting the center of gravity closer to or farther from the front ski 108. The adjustable limiter strap 138 determines how far away the forward shock 124 can push down the leading edge of the hyfax slide assembly 132. The front leading edge of the hyfax slide suspension 132 is also turned up to provide an approach angle in the range of between about 5 and 30 degrees.

During acceleration and increased loading, the leverage and geometry of the adjustable shock and strut combination is such that the center-point of the track 120, that is supporting the backend weight of snow bike system 100, will dynamically shift further back. The front of the snow bike system 100 will have to take more of the static weight as a result, and the increased static weight will keep the front ski 108 down on the ground and better maintain steering. Such is represented in FIG. 1 by the “dynamic loading point” arrow which can shift forward or back.

A rear track roller 139, in one embodiment, is mounted to the rear end of hyfax slide suspension 132. A jackshaft 140 in a sealed case couples the engine power on a chain and sprocket to a more outboard position where it can power a forward track roller and track drive wheel (covered by tunnel 118 and not shown in FIG. 1) inside the front loop of track 120.

In one embodiment, the length of the rear strut 130 is adjustable. The degree coupling of the back suspension and the amount of lift that will develop on the front ski 108 when climbing a hill can be changed by adjusting the length of rear strut 130. Such adjustment also affects how independent the front and back portions of the hyfax suspension 132 will be from one another, as well as the rear ride height of motorcycle 102.

The geometric relationship of the front and rear adjustable shocks 124 and 126 with their associated front and rear struts 128 and 130 balances the pressures applied to the snow between the front and back halves of the track 120 under the hyfax slide suspension 132. In one embodiment, about 13″ of vertical travel is achieved.

The system 100, as depicted, includes a drive system jackshaft 140. The jackshaft 140, beneficially, positions the drive to the outside of the tunnel rail 118 and allows the above described width of the track 120. In one embodiment, the snow bike system 100 described is a conversion or add-on kit to modify a previously manufactured motorcycle 102 to allow efficient over the snow and ice travel. The front wheel 104, the rear wheel 106, and the swing arm suspension are removed, in one embodiment, to allow for the conversion of the motorcycle into a snow vehicle. A single steering ski 108 is installed in the place of the front wheel to provide for steering. The ski 108 is formed, as depicted, having a ground engaging surface 142. The ground engaging surface 142 may be formed with an upturned tip 144, a tail 146, and a base portion, or ground engaging surface 148, disposed between the tip 144 and the tail 146.

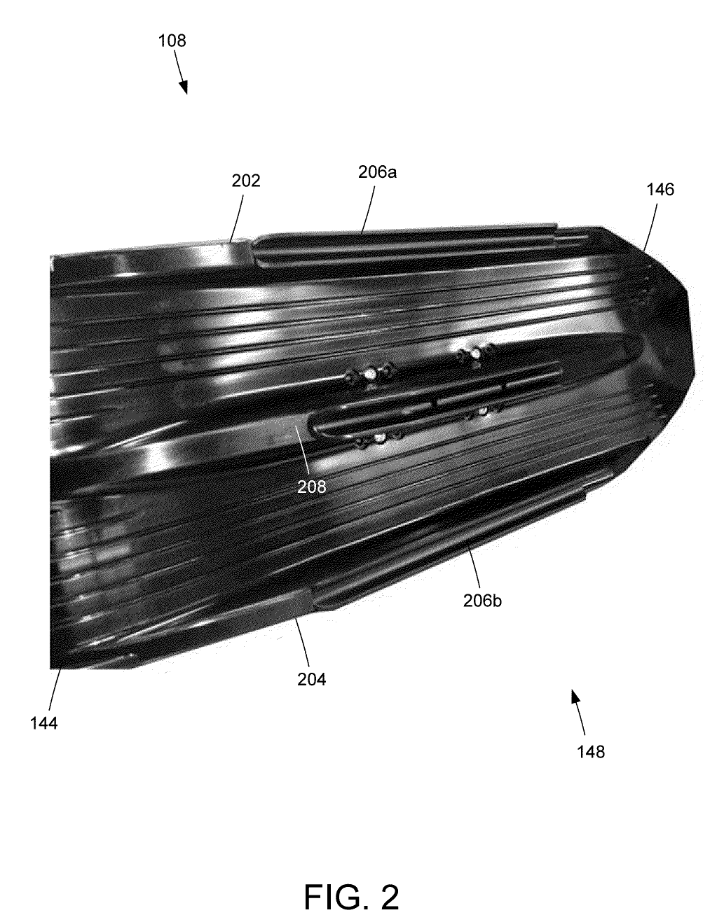

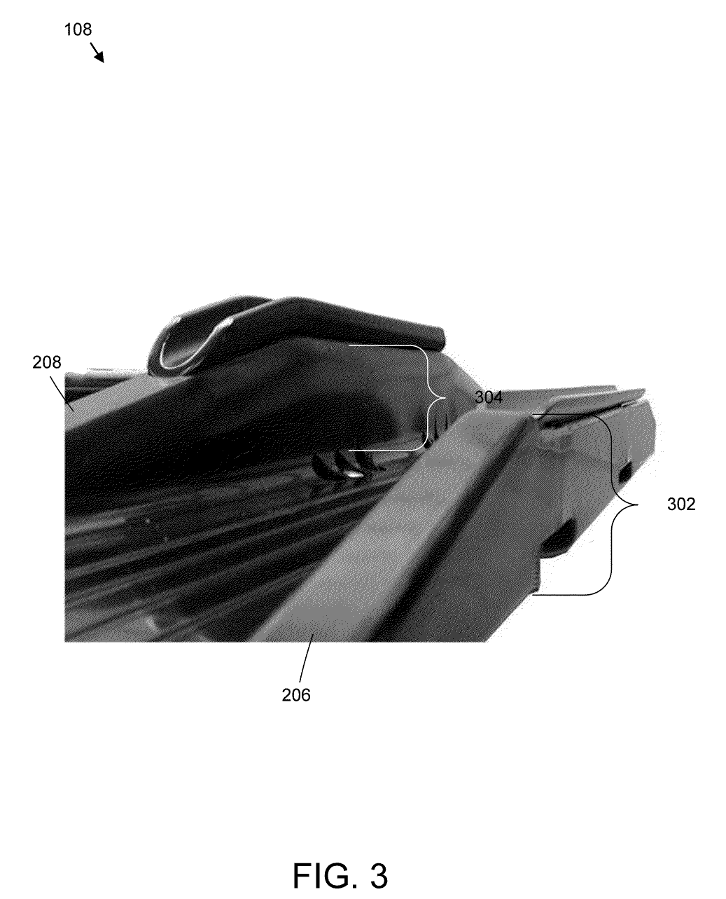

The top surface of the ski 108 is coupled with a bracket for connecting the ski 108 with the forks of the motorcycle. A mounting bracket may pivotally couple the ski with the forks so that impacts from snow covered terrain is transmitted through the bracket to the fork suspension system of the motorcycle. The ski 108 will be discussed in greater detail below with reference to FIGS. 2 and 3.

A rear track drive assembly 132 is installed in the place of the rear wheel and swing arm suspension. The rear track drive assembly 132, in one example, includes track slides 134, 136 and a track 120 coupled to the engine 103 via the chain case 140. The track 120 may be driven between a forward track roller and a rear track roller 139 suspended with and positioned fore and aft of the track slides 134, 136.

FIG. 2 is a perspective view diagram illustrating one embodiment of the ground engaging surface 148 of the ski steering assembly in accordance with embodiments of the invention. As described above, the converted snow vehicle is piloted using the single ski 108. The ski 108 may be formed of a substantially rigid material with a low coefficient of friction on ice and snow. Additionally, the rigid material may have a low modulus of elasticity as compared to metal. In one embodiment, the rigid material is compression molded from a polymer such as, but not limited to ultra-high-molecular-weight polyethylene.

The ground engaging surface 148, as depicted, extends from the tip 144 to the tail 146 in a longitudinal direction. The ground engaging surface 148 has a width that extends from a first edge 202 to a second edge 204. In one embodiment, keels 206 extend outward from the ground engaging surface. The keels 206 may be located at different positions relative to the edges 202, 204. For example, keels 206 may be positioned, as depicted, at the edges 202, 204. A center keel 208 may extend substantially along a longitudinal axis (not shown) that bisects the ground engaging surface 142. Alternatively, the center keel 208 may be offset from the longitudinal axis. The keels 206, 208 are substantially parallel to the edges 202, 204 and generally extend across a substantial area of the ground engaging surface 142. In other words, the keels 204, 206 may extend across the length of the ground engaging surface 148 between the tip 144 and the tail 146.

The keels 206, 208 form a contoured gliding surface. In one embodiment, the contoured gliding surface includes at least two concave regions. Each concave region is formed on one side by an edge keel (e.g., keel 206) and the center keel (e.g., keel 208). The concave regions help to funnel snow and lift the ski 108, and accordingly, the motorcycle or snow-vehicle. In one embodiment, the distance between the center keel 208 and an adjacent side keel 206 is in the range of between about 1 and 8 inches. The arrangement of the edge keels 206 and the center keel 208 may be symmetrical. Stated differently, the center keel 208 may be positioned at the midpoint between the edge keels 206 thereby forming two substantially equivalent concave regions. In an alternative embodiment, the center keel 208 is offset. In other words, the center keel 208 may be positioned closer to one of the edge keels 206a than the other edge keel 206b.

The width of each keel 206, 208 may be in the range of between about 0.25 and 2 inches. The width of the keels 206, 208 may vary along the length of the keel 206, 208. For example, the width of the keels 206, 208 may taper at both ends, with the greatest width in the middle. This varying width causes the concave regions to also vary in width. In other terms, each concave region may have a narrowing width, which may provide greater lift to the ski 108.

FIG. 3 is a perspective view diagram illustrating another embodiment of the ground engaging surface 148 in accordance with embodiments of the invention. In one embodiment, the edge keel 206 (when referenced separately, keels 206a or 206b) extends from the ski base, or ground engaging surface 148, to a height 302 that is less than a height 304 of the center keel 208. In another embodiment, the edge keel 206 extends to a distance substantially equivalent to that of the center keel 208. In another embodiment, the edge keel 206 extends to a distance 306 greater than the height 304 of the center keel 208. This height 302 of the edge keel 206 may be in the range of between about 0.25 and 3 inches. The height 304 of the center keel 208 may be in the range of between about 0.25 and 4 inches. In one embodiment, the ratio of the height of the center keel 208 to the height of the edge keel 206 is in the range of between about 3:1 and 1:1. In another embodiment, the height of the center keel 208 is at least 0.25 inches greater than the height of either of the side keels 206.

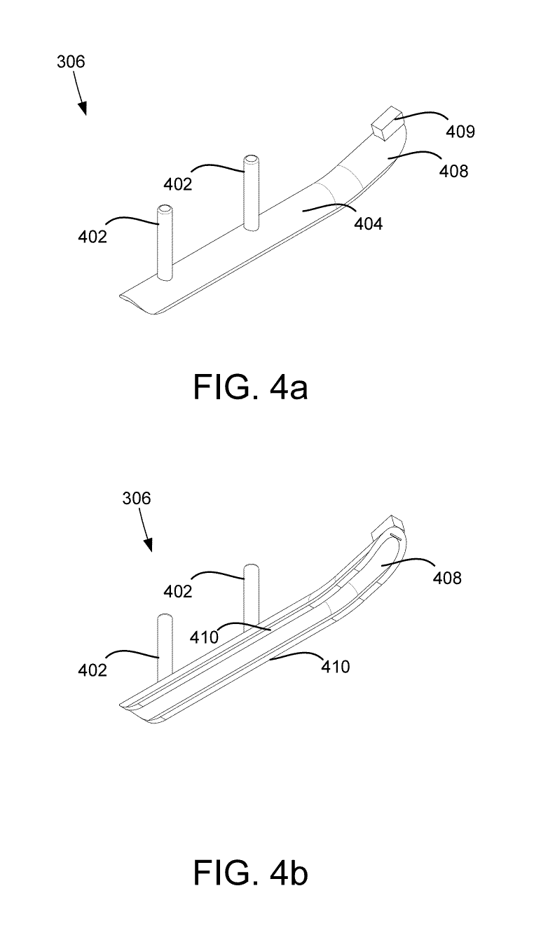

A taller center keel 208 beneficially allows the snow-vehicle to track better on groomed trails. Instead of “hunting” (i.e., jumping from one track to another on a trail that has previously been traveled by other snow-vehicles), the taller center keel 208 maintains a consistent travel path as desired by the rider. In one embodiment, a wear bar 306 may be coupled with the edge or center keel 206, 208. The wear bar 306 will be discussed in greater detail below with reference to FIGS. 4a and 4b.

FIGS. 4a and 4b are perspective view diagrams illustrating embodiments of wear bars 306 in accordance with embodiments of the invention. The wear bar 306 is positioned on the ski 108 to make initial contact with harder surfaces such as packed or icy trails, and/or roads. The wear bar 306 is designed to enhance the turning ability of the ski 108 by causing the ski to adhere to an intended direction of travel. The wear bar 306 may be formed of a hardened metal material. Examples of hardened metal materials suitable for use with embodiments of the invention include, but are not limited to, hardened steel, and various carbide compositions. The wear bar 306 may be formed by any suitable manufacturing method including, but not limited to, stamping, cutting, or molding. Examples of molding may include powder metal molding, casting, or forging.

The wear bar 306, in one embodiment, is insertable into the ski. The wear bar 306 may include risers 402 which are configured for attaching the wear bar 306 to the ski. The risers may, for example, be configured to receive fasteners. In other words, the risers are configured to pass through openings in the ski 108 and receive the fasteners, thereby securing the wear bar 306 to the ski.

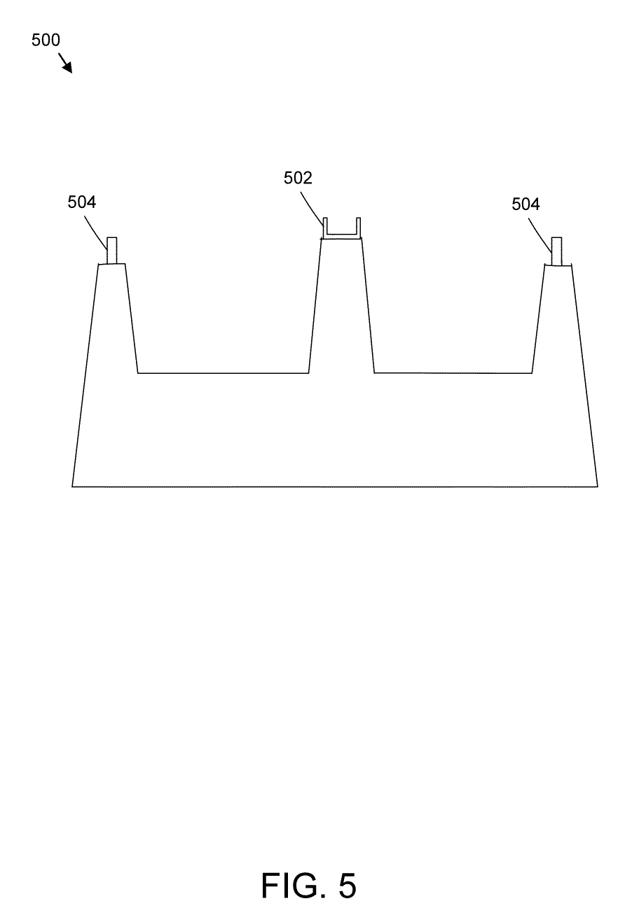

FIG. 4a illustrates a top view of the wear bar 306. A top surface 404 of the wear bar 306 may be contoured to engage (i.e., embed into) a channel in the ski 108. Although the depicted embodiment illustrates a wear bar 306 having a generally rounded top surface 404, the wear bar 306 may be formed, for example, having a rectangular cross-sectional profile (see FIG. 5). Subsequently, the ski may have a rectangular channel for receiving the top surface 404 of the wear bar 306. In one embodiment, the wear bar 306 may have an upturned tip 408. The upturned tip 408 is configured to engage a slope of a corresponding keel. Additionally, the upturned tip 408 may include a raised portion 409 that is configured to engage a slot or opening in the ski 108. Alternatively, the wear bar 306 may be substantially straight without an upturned tip or tail, depending on the longitudinal profile of a corresponding keel.

FIG. 4b illustrates a bottom view (i.e., ground engaging surface) of one embodiment of the wear bar 306 having a plurality of downwardly extending ridges 410 in accordance with embodiments of the invention. The plurality of downwardly extending ridges 410 focus the weight of the snow-vehicle on a smaller surface area when on hard surfaces, and thereby act as runners or guides for improved steering control. The wear bar 306 may be formed of a hardened material such as a carbon metallic compound. Examples of a metallic component of the compound include, but are not limited to, tungsten, tantalum, titanium, and chromium.

The wear bar 306, in the depicted embodiment, has a cross-sectional profile resembling a half-circle. The downwardly extending ridges 410, in one example, arc upward and form the half-circle. The thickness of each ridge 410 is in the range of between about 0.01 and 1 inch. The distance between ridges 410 is in the range of between about 0.01 and 2 inches. In a further embodiment, the distance between the ridges 410 is in the range of between about 0.25 and 1.5 inches. In yet another embodiment, the distance between the ridges is about 1 inch. In other embodiments, the cross-sectional profile of the wear bar 306 is configured to resemble, for example, a half-square. Other cross-sectional profiles are contemplated, including but not limited to, half-ovals, half-hexagon, etc. In other words, any cross-sectional profile may be used that implements a pair of downwardly extending ridges 410 that form a concave region.

The ridges 410 form the boundaries of a concave region of the wear bar 306 that extends along a longitudinal axis of the wear bar 306. The ridges 410, beneficially, enhance handling while travelling on hard-packed surfaces. Each ski 108 may include one or more wear bars 306. In one embodiment, each keel 206, 208 is equipped with a wear bar 306. The length of each wear bar 306 may be selected according to the length of the keel to which the wear bar 306 corresponds. In other words, the length of each wear bar 306 is selected to match the keel. Alternatively, the length of each wear bar 306 is the same. In one embodiment, the length of the wear bar 306 is in the range of between about 1 and 10 inches.

FIG. 5 is a schematic block diagram illustrating one embodiment of a ski cross-section 500 in accordance with embodiments of the present invention. The cross-section of the ski depicts, as described above, a wear bar 502 having a square, or U-shaped, cross-sectional profile. Additionally, the wear bars 504 attached to the outer keels may comprise single-ridges, as depicted.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the subject matter of the present disclosure may be combined in any suitable manner in one or more embodiments. One skilled in the relevant art will recognize that the subject matter may be practiced without one or more of the specific features or advantages of a particular embodiment. In other instances, additional features and advantages may be recognized in certain embodiments that may not be present in all embodiments. These features and advantages will become more fully apparent from the following description and appended claims, or may be learned by the practice of the subject matter as set forth hereinafter.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

Furthermore, the details, including the features, structures, or characteristics, of the subject matter described herein may be combined in any suitable manner in one or more embodiments. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the disclosed subject matter.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A snow ski comprising:
a base having a top surface for coupling to a snow vehicle, and a bottom surface for gliding over snow and ice, where the base extends longitudinally from a tip to a tail;
a first keel extending along a first lateral edge of the base;
a second keel extending along a second lateral edge of the base;
a third keel extending along a longitudinal axis of the base, and where the third keel extends downwardly from the base a distance greater than the first keel; and
a plurality of wear bars, where each of the first keel, the second keel, and the third keel is coupled with a corresponding one of the plurality of wear bars.

2. The snow ski of claim 1, where each of the plurality of wear bars comprises an elongated, hardened member comprising a pair of downwardly extending ridges along the lateral edges of the elongated, hardened member.

3. The snow ski of claim 2, where the pair of downwardly extending ridges form a concave region.

4. The snow ski of claim 2, where each of the plurality of wear bars includes a top surface that is contoured to engage a corresponding one of a plurality of channels formed in one of either the first keel, the second keel, or the third keel.

5. The snow ski of claim 2, where each of the plurality of wear bars includes an upturned tip configured to engage a slope of one of either the first keel, the second keel, or the third keel.

6. The snow ski of claim 5, where the upturned tip includes a raised portion configured to engage an opening in one of either the first keel, the second keel, or the third keel.

7. The snow ski of claim 2, where each of the plurality of wear bars comprises a substantially half-circular lateral cross-sectional profile.

8. The snow ski of claim 7, where a distance between the pair of downwardly extending ridges is in the range of between about 0.25 and 0.5 inches.

9. A system comprising:
a motorcycle frame supporting an engine for driving an endless track, wherein the motorcycle frame couples at a rear end to a rear suspension system;
wherein the rear suspension system comprises:
a subframe;
a strut disposed between the subframe and the motorcycle frame that couples the subframe with the frame;
a tunnel coupled with the subframe and comprising a plurality of upper rollers for supporting an upper portion of the endless track;
a shock coupling a track slide to the tunnel, wherein the track slide comprises a plurality of lower rollers for supporting a lower portion of the endless track; and
wherein the track slide, the shock, the plurality of upper rollers, and the plurality of lower rollers are disposed within the endless track; and
wherein the motorcycle frame couples at a front end to a front suspension system, the front suspension system comprising a snow ski, where the snow ski comprises:
at least one wear bar assembly comprising a pair of downwardly extending ridges forming a concave region extending along a length of the wear bar assembly.

10. The system of claim 9, where the at least one wear bar includes a top surface that is contoured to engage a channel formed in the snow ski.

11. The system of claim 10, where the at least one wear bar includes an upturned tip configured to engage a slope of a keel of the snow ski.

12. The system of claim 11, where the upturned tip includes a raised portion configured to engage an opening in the keel.

13. The system of claim 10, where the at least one wear bar comprises a substantially half-circular lateral cross-sectional profile.

14. The system of claim 13, where a distance between the pair of downwardly extending ridges is in the range of between about 0.25 and 0.5 inches.

15. A wear bar assembly comprising a wear bar for attachment to a bottom of a snow vehicle ski, where the wear bar comprises a pair of downwardly extending ridges forming a concave region extending along a length of the wear bar.

16. The wear bar assembly of claim 15, where the wear bar assembly comprises a substantially half-circular lateral cross-sectional profile.

17. The wear bar assembly of claim 15, further comprising a top surface that is contoured to engage a keel of a snow vehicle ski.

18. The wear bar assembly of claim 17, further comprising an upturned tip configured to engage a slope of a keel of the snow vehicle ski.

19. The wear bar assembly of claim 18, where the upturned tip includes a raised portion configured to engage an opening in the keel.

20. The wear bar assembly of claim 15, where a distance between the pair of downwardly extending ridges is in the range of between about 0.25 and 0.5 inches.
